(19) United States
(12) Patent Application Publication
(10) Pub. No.: US 2008/0225766 A1
(43) Pub. Date: Sep. 18, 2008

(54) METHOD AND APPARATUS FOR RECONFIGURING MEDIUM ACCESS CONTROL COMPONENTS IN WIRELESS COMMUNICATIONS

(75) Inventors: Vincent Roy, Montreal (CA); Christopher R. Cave, Verdun (CA); Paul Marinier, Brossard (CA); Diana Pani, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/048,901

(22) Filed: Mar. 14, 2008

Related U.S. Application Data
(60) Provisional application No. 60/894,934, filed on Mar. 15, 2007.
(60) Provisional application No. 60/914,776, filed on Apr. 30, 2007.
(60) Provisional application No. 60/982,683, filed on Oct. 25, 2007.

(51) Int. Cl. H04B 7/00

(52) U.S. Cl. 370/310

(57) ABSTRACT

Methods and apparatus are disclosed to facilitate wireless communications between a wireless transmit receive unit (WTRU), legacy base stations and base stations using different operating parameters, such as evolved high speed packet access (HSPA) systems Third Generation Partnership Project ((3GPP) Release 7, Release 8 and beyond). Preferred WTRUs are configured with a medium access control (MAC) sub-layer component having a subcomponent with HARQ buffers, such as a subcomponent configured to provide MAC-es and MAC-e functionality and/or MAC-is and MACi functionality that include hybrid automatic repeat request (HARQ) processes, some of which are preferably operable with enhanced dedicated transport channels (E-DCH). The WTRUs are preferably configured such that they reconfigure their MAC subcomponents during soft handover while minimizing induced latency and data losses associated with HARQ processes. In some embodiments, the WTRUs are configured to prevent flushing of HARQ process buffers in soft handover scenarios with a Node B that does not support UL enhancements, e.g. higher order modulation (HOM). In other embodiments, flushing of HARQ processes is used but amelioration of adverse effects is addressed.

### CROSS REFERENCE TO RELATED APPLICATIONS

This application claims the benefit of U.S. provisional application No. 60/894,934 filed Mar. 15, 2007, U.S. provisional application No. 60/914,776 filed Apr. 30, 2007, and U.S. provisional application No. 60/982,683 filed Oct. 25, 2007, which are all incorporated by reference as if fully set.

### FIELD OF INVENTION

The present invention is related to methods and apparatus for reconfiguring medium access control (MAC) components of a wireless transmit receive unit (WTRU) to facilitate wireless communications. More particularly, the present invention is related to facilitate wireless communications during soft handovers that require reconfigurations due to differing functionalities of a radio access network.

### BACKGROUND

Wireless transmit receive units (WTRUs) configured with stacked protocol layer components are well known in the art. In some WTRUs the radio interface is layered into protocol layers: a physical layer (L1), a data link layer (L2), and higher layers. L2 is commonly divided into a medium access control (MAC) sub-layer, a radio link control (RLC) sub-layer, a packet data convergence protocol (PDCP) sub-layer, and a broadcast/multicast control (BMC) sub-layer. The interaction between the MAC layer and the physical L1 layer is conventionally conducted through the use of data elements commonly called primitives, where the primitives represent the logical exchange of information and control. The RLC is commonly divided into control (C-) and User (U-) planes. In the C-plane, a higher layer is typically partitioned into sub-layers where the lowest is denoted as radio resource control (RRC) and interfaces with L2. The MAC sub-layer can be made up of several different MAC entities, such as MAC-d, MAC-c/sh/m, MAC-hs, MAC-es/MAC-e, and MAC-m or newer MAC-is/MACi entities. The MAC-es/MAC-e or MAC-is/MACi entities provide hybrid automatic repeat request (HARQ) functionality and are only used with enhanced dedicated transport channels (E-DCH).

The evolution of high speed packet access (HSPA) towards higher throughput and lower latencies requires improvements to the physical layer as well as possible changes to the architecture. One improvement that has been proposed is the use of Higher-Order Modulations (HOM) in the uplink (UL), i.e. communications to a network base station, along with enhanced base station receiver capabilities. The use of HOM allows WTRUs to transmit at higher transmission rates, which implies that HSPA systems will support larger Transport Block (TB) sizes, which define the amount of data transmitted in a particular time slot or interval. Hence, new sets of enhanced dedicated channel (E-DCH) Transport Format Combinations (E-TFC) and E-DCH Transport Format Combinations Indicators (E-TFCI). To support these without adding MAC header overhead, while maintaining backward compatibility, new tables of E-TFCI were defined. The mapping between E-TFCI and TB size depends on which E-TFCI table the WTRU is configured to use. This configuration is done by the higher layers, e.g. Radio Resource Control (RRC) signaling, using the E-TFCI table index parameter.

Two MAC sub-layers, MAC-es and MAC-e, were introduced in the high speed uplink packet access (HSUPA). The MAC-es is a peer-to-peer layer sub between a WTRU and a serving radio network controller (SRNC). The MAC-e is a peer-to-peer layer between the WTRU and a base station, commonly called a Node-B. To implement MAC-e/es protocol layer functionality, a subcomponent of a MAC layer component is included in the WTRU. The MAC-e/es subcomponents implement HARQ processes, multiplexing, transmission sequence number (TSN) setting, enhanced transport format combination (E-TFC) selection for performing HARQ retransmissions, MAC-e packet multiplexing, E-TFC selection and a variety of other specified functions. As part of Third Generation Partnership Project (3GPP) Release 8, the MAC-es/e entity becomes MAC-is/i when operating with L2 improvements, i.e. flexible size Radio Link Control Protocol Data Units (RLC PDUs) and MAC segmentation.

The MAC subcomponents perform data encapsulation for the various MAC layers. For example, a MAC-d sub-layer generally receives the RLC PDUs for one or more logical channels to form MAC-d PDUs. A MAC subcomponent implementing MAC-es functionality typically uses the MAC-d PDUs to form the payload for MAC-es PDUs which conventionally include a TSN header. A MAC-e subcomponent typically uses the MAC-es PDUs to form the payload for MAC-e PDUs. Padding bits may be added as necessary to fill out the payload at each stage of data encapsulation. For HARQ processes, the respective MAC subcomponents typically include one or more buffers to temporarily store MAC-e PDUs and/or MAC-es PDUs for retransmissions.

In 3GPP Release 8, Uplink layer 2 improvements are introduced. The Uplink layer 2 improvements target enhancements to the layer 2 protocols, more specifically Radio Link Control (RLC) and MAC. An objective of this work item includes support for flexible Radio Link Control Protocol Data Unit (RLC PDU) size, segmentation capabilities at the MAC layer, and to allow smooth transitions between old and new protocol formats. The inventors have recognized the need to introduce and define new MAC-e/es header formats to support layer 2 improvements.

In a context where some network base stations, commonly called a Node Bs, that support UL enhancements coexist with other Node Bs that do not support UL enhancements, a WTRU connected to a Node B enabled with UL enhancements can encounter situations requiring soft handover to a Node B that does not support UL enhancements. For example, a mobile WTRU may travel from the service area of a Node B enabled with UL enhancements into the service area of a Node B that does not support UL enhancements during a communication. During soft handover, a WTRU establishes a plurality of connections with a plurality of Node-Bs in an active set. In this scenario, a WTRU configured to use one of the E-TFCI tables defined for UL HOM would have to change the E-TFCI table it was using in order to be able to communicate with the Node B that has just entered the active set. The MAC es/e of the WTRU would then have to be reconfigured through the higher layers for the WTRU to use E-TFCI tables that both Node Bs can support.

Currently, the way this can be done is by resetting the MAC es/e through a MAC-es/e Reset operation combined with a required E-TFCI table index parameter change. The inventors have recognized that this is problematic in view of the use of HARQ processes which are employed to ensure the complete transmission of data by repeating transmissions under certain circumstances.

In HARQ processes MAC subcomponent buffers, such as a send buffer, are used to store data, typically formatted PDUs for retransmission. This enables the WTRU to hold the data for uplink until the data or data packets are successfully communicated to the Node B or other network component either in an original transmission or a retransmission. Typically, once a data packet is successfully received, the WTRU removes the packet from its MAC send buffer.

In case of HSUPA, a serving RNC (SRNC) or a Node B that is in communication with the WTRU during a soft handover may at times determine that the WTRU send buffer should be flushed, i.e. cleared, by a MAC-es/e Reset operation which removes all temporarily stored packets, even if HARQ processes have not been completed, such as when packets have not been acknowledged as being successfully received.

The inventors have recognized that since the MAC-es/e Reset operation forces the WTRU to flush all HARQ processes this will result in loss of data at the MAC layer and translates into either undue latency, if the RLC is configured in Acknowledged Mode, or in data losses, if the RLC is configured in Unacknowledged Mode. Accordingly the inventors have recognized that it would be desirable to provide a procedure and component to reconfigure the MAC es/e without being subject to the limitations of the prior art.

### SUMMARY

Methods and apparatus are provided to facilitate wireless communications between a wireless transmit receive unit (WTRU), legacy base stations and base stations using different operating parameters, such as evolved high speed packet access (HSPA) systems Third Generation Partnership Project ((3GPP) Release 7, Release 8 and beyond). Preferred WTRUs are configured with a medium access control (MAC) sub-layer component having a subcomponent with HARQ buffers, such as a subcomponent configured to provide MAC-es and MAC-e functionality and/or MAC-is and MACi functionality that include hybrid automatic repeat request (HARQ) processes, some of which are preferably operable with enhanced dedicated transport channels (E-DCH). The WTRUs are preferably configured such that they reconfigure their MAC subcomponents during soft handover while minimizing induced latency and data losses associated with HARQ processes.

In some embodiments, the WTRUs are configured to prevent flushing of HARQ process buffers in soft handover scenarios with a Node B that does not support UL enhancements, e.g. higher order modulation (HOM). In other embodiments, flushing of HARQ processes is used but amelioration of adverse effects is addressed.

In one embodiment a WTRU has a configurable MAC component having a subcomponent configured to provide HARQ functionality, such as support for enhanced dedicated transport channels (E-DCH). The MAC component is preferably configured to implement a reconfiguration of the MAC subcomponent at an activation time from a first configuration to a second configuration based upon receipt of reconfiguration parameters such that the second configuration is used by the MAC subcomponent subsequent to the activation time, except for incomplete HARQ processes existing at the activation time. Preferably, at least a portion of the first configuration is used by the MAC subcomponent for completion of incomplete HARQ processes existing at the activation time.

The WTRU's MAC component may be configured to implement reconfiguration of the MAC subcomponent for a plurality of operational modes including enhanced modes of operation and non-enhanced modes of operation. The MAC component is preferably configured to utilize an enhanced mode of operation for HARQ processes initiated after the activation time in implementing a reconfiguration of the MAC subcomponent where the first configuration uses a non-enhanced mode of operation and the second configuration uses the enhanced mode of operation. The MAC component is preferably configured to not to utilize an enhanced mode of operation for HARQ processes initiated after the activation time in implementing a reconfiguration of the MAC subcomponent where the first configuration uses the enhanced mode of operation and the second configuration uses a non-enhanced mode of operation.

Where the MAC subcomponent has an uplink 16 quadrature amplitude modulation (QAM) mode of operation, the MAC component may be configured to receive an ACTIVE SET UPDATE message to trigger a reconfiguration of the MAC subcomponent to a different mode of operation In such case, the MAC component is preferably configured to utilize the uplink 16 QAM mode of operation for HARQ processes initiated after the activation time in implementing a reconfiguration of the MAC subcomponent where the first configuration uses a non-enhanced mode of operation and the second configuration uses the uplink 16 QAM mode of operation and the MAC component is preferably configured to not to utilize the uplink 16 QAM mode of operation for HARQ processes initiated after the activation time in implementing a reconfiguration of the MAC subcomponent where the first configuration uses the uplink 16 QAM mode of operation and the second configuration uses a non-enhanced mode of operation.

In another embodiment, a WTRU has a configurable MAC component having a subcomponent configured to provide HARQ functionality where the MAC component is configured to implement reconfiguration of the MAC subcomponent for a plurality of operational modes including an enhanced mode and a non-enhanced mode; and the MAC component is configured to utilize an Information Element (IE) that specifically indicates whether or not to flush HARQ processes in connection with implementing a reconfiguration of the MAC subcomponent from one operational mode to another. The MAC subcomponent may have an uplink 16 QAM mode of operation as an enhanced mode of operation and the MAC component may be configured to receive an ACTIVE SET UPDATE message to trigger a reconfiguration of the MAC subcomponent to a different mode of operation. In such case, the IE is preferably included within the ACTIVE SET UPDATE message, within another IE contained in the ACTIVE_SET_UPDATE message or within another IE contained in another message. The MAC subcomponent may alternatively or additionally have an uplink L2 mode of operation as an enhanced mode of operation.

In another embodiment, a WTRU has a configurable MAC component having a subcomponent configured to provide HARQ functionality where the MAC component is configured to implement reconfiguration of the MAC subcomponent for a plurality of operational modes including enhanced modes of operation and non-enhanced modes of operation and the MAC component is configured to selectively flush HARQ processes in implementing a reconfiguration of the MAC subcomponent. Preferably, HARQ processes are flushed for reconfigurations which changes the mode of operation from an enhanced mode of operation to a non-enhanced mode of operation or from a non-enhanced mode of operation to an enhanced mode of operation. Preferably, HARQ processes are not flushed in implementing a reconfiguration of the MAC subcomponent which does not change the mode of operation from an enhanced mode of operation to a non-enhanced mode of operation or from a non-enhanced mode of operation to an enhanced mode of operation.

In one example, the MAC subcomponent has an uplink 16 QAM mode of operation and the MAC component is configured to receive an ACTIVE SET UPDATE message to trigger a reconfiguration of the MAC subcomponent to a different mode of operation. In such example, the MAC component is configured to flush HARQ processes in implementing a reconfiguration of the MAC subcomponent which changes the mode of operation from the an uplink 16 QAM enhanced mode of operation to a non-enhanced mode of operation in response to the inclusion of an UL 16QAM settings Information Element in a triggering ACTIVE SET UPDATE message or from a non-enhanced mode of operation to an enhanced mode of operation in response to the omission of an UL 16QAM settings Information Element in a triggering ACTIVE SET UPDATE message and the MAC component configured not to flush HARQ processes in implementing a reconfiguration of the MAC subcomponent which does not change the mode of operation from an enhanced mode of operation to a non-enhanced mode of operation or from a non-enhanced mode of operation to an enhanced mode of operation irrespective of whether an UL 16QAM settings Information Element in a triggering ACTIVE SET UPDATE message is included or omitted.

In another embodiment, a WTRU has a configurable MAC component having a subcomponent configured to provide HARQ functionality where the MAC component is configured to implement a reconfiguration of the MAC subcomponent at an activation time from a first configuration to a second configuration based upon receipt of reconfiguration parameters and the MAC subcomponent has a plurality of operational modes including enhanced modes of operation and non-enhanced modes of operation. In this embodiment, the MAC component is preferably configured to utilize an enhanced mode of operation for HARQ processes initiated after the activation time in implementing a reconfiguration of the MAC subcomponent where the first configuration uses a non-enhanced mode of operation and the second configuration uses the enhanced mode of operation. The MAC component is also preferably configured to not to utilize an enhanced mode of operation for HARQ processes initiated after the activation time in implementing a reconfiguration of the MAC subcomponent where the first configuration uses the enhanced mode of operation and the second configuration uses a non-enhanced mode of operation.

In one example, the MAC subcomponent has an uplink 16 QAM mode of operation and the MAC component is configured to receive an ACTIVE SET UPDATE message to trigger a reconfiguration of the MAC subcomponent to a different mode of operation. In such example, the MAC component is preferably configured to utilize the uplink 16 QAM mode of operation for HARQ processes initiated after the activation time in implementing a reconfiguration of the MAC subcomponent where the first configuration uses a non-enhanced mode of operation and the second configuration uses the uplink 16 QAM mode of operation. The MAC component is also preferably configured to not to utilize the uplink 16 QAM mode of operation for HARQ processes initiated after the activation time in implementing a reconfiguration of the MAC subcomponent where the first configuration uses the uplink 16 QAM mode of operation and the second configuration uses a non-enhanced mode of operation.

In a further embodiment, a WTRU has a configurable MAC component having a subcomponent configured to HARQ functionality where the MAC subcomponent includes a buffer for temporarily storing retransmission data associated with initiated HARQ processes and the MAC component is configured to implement a reconfiguration of the MAC subcomponent at an activation time from a first configuration to a second configuration based upon receipt of reconfiguration parameters such that the second configuration is used by the MAC subcomponent subsequent to the activation time, and data stored in the buffer with respect to incomplete HARQ processes existing at the activation time is reprocessed for possible transmission using the second configuration. The MAC subcomponent may have a plurality of configurations which operate to encapsulate data into transport blocks (TB) having selected sizes where there are at least two different configurations that use different sets of TB sizes. In such case, the MAC subcomponent, when operating in a selected configuration, is preferably configured to use the buffer to temporarily store data that has been encapsulated and padded into transport blocks (TBs) that are sized in accordance with the set of TB sizes used by the selected configuration. The MAC component is then preferably further configured to implement a reconfiguration of the MAC subcomponent at an activation time from a first configuration to a second configuration based upon receipt of reconfiguration parameters such that data stored in the buffer with respect to incomplete HARQ processes existing at the activation time is reprocessed by extracting the encapsulated data stored in the buffer and performing a re-padding procedure to fit the extracted data into TBs of a size used by the second configuration unless the extracted data is too large for any of the TBs used by the second configuration.

In one example, the MAC subcomponent has a plurality of configurations which operate to encapsulate data into transport blocks (TB) having selected sizes such that the configurations include a MAC-es/e configuration wherein the MAC subcomponent is configured to implement MAC-e and MAC-es protocol sub-layer functionality for the WTRU in which data associated with HARQ processes is stored in the buffer in the form MAC-e protocol data units and a MAC-is/i configuration wherein the MAC subcomponent is configured to implement MAC-i and MAC-is protocol sub-layer functionality for the WTRU in which data associated with HARQ processes is stored in the buffer in the form MAC-i protocol data units. In such example, the MAC component is preferably configured to implement a reconfiguration of the MAC subcomponent at an activation time from the MAC-es/e configuration to the MAC-is/i configuration based upon receipt of reconfiguration parameters such that the MAC-is/i configuration is used by the MAC subcomponent subsequent to the activation time, and data stored in the buffer as MAC-e protocol data units with respect to incomplete HARQ processes existing at the activation time is reprocessed into MAC-i protocol data units for transmission using the MAC-is/i configuration.

In another embodiment, a WTRU has a configurable MAC component having a subcomponent configured to provide HARQ functionality where the MAC subcomponent includes a buffer for temporarily storing retransmission data associated with initiated HARQ processes and the MAC component configured to implement a reconfiguration of the MAC subcomponent at an activation time from a first configuration to a second configuration based upon receipt of reconfiguration parameters such that the second configuration is used by the MAC subcomponent subsequent to the activation time and incomplete HARQ processes existing at the activation time are flushed. A radio link control (RLC) component implements RLC sub-layer functionality for the WTRU including the communication of data with the MAC component in RLC packet data units (PDUs). Preferably, the MAC component and the RLC component are configured to utilize a set of primitives to identify incomplete HARQ processes existing at the activation time. The MAC component is preferably configured to encapsulate RLC PDUs in MAC subcomponent PDUs for transmission and to temporarily store MAC subcomponent PDUs associated with initiated HARQ processes in the buffer. The MAC component and the RLC component are then preferably further configured to utilize the set of primitives to identify encapsulated RLC PDUs in MAC subcomponent PDUs stored in the buffer for incomplete HARQ processes existing at the activation time.

In any of the embodiments, the WTRU's MAC subcomponent may be configured to implement MAC-e and MAC-es protocol sub-layer functionality and/or MAC-i and MAC-is protocol sub-layer functionality for the WTRU and preferably includes a buffer for temporarily storing retransmission data associated with initiated HARQ processes that is cleared when HARQ processes are flushed. Additionally, features of the various embodiments may be combined with each other.

### BRIEF DESCRIPTION OF THE DRAWINGS

A more detailed understanding may be had from the following description, given by way of example and to be understood in conjunction with the accompanying drawings.

FIG. 1 is a block diagram of a soft handover for a wireless transmit receive unit between a Node B without uplink enhancements and a Node B with uplink enhancements.

FIG. 2 is an exemplary diagram of the treatment of HARQ processes in connection with MAC reconfiguration in accordance with one embodiment of the invention.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

The present application is directed to WTRUs configured with MAC component having subcomponents with data buffers that implement HARQ processes. Preferably, the WTRUs are configured to use uplink (UL) enhancements, HOM or UL Layer 2 (L2) improvements. The WTRUs may be configured such that flushing of WTRU HARQ processes is prevented even when the WTRU is in a soft handover where an active set includes a Node-B that does not support UL enhancements. Several preferred configurations are disclosed.

Components and procedures are described herein to handle the transmissions of HARQ processes on which a MAC PDU transmission was initiated before an activation time, such as by an identified Transmission Time Interval (TTI), but not completed at the activation time. The WTRU configurations and procedures are directed to limiting the latency impact of flushing HARQ processes that can be induced by MAC reconfiguration involving a MAC-es/e reset or the like that direct the flushing of HARQ process buffers and/or to providing alternatives to flushing.

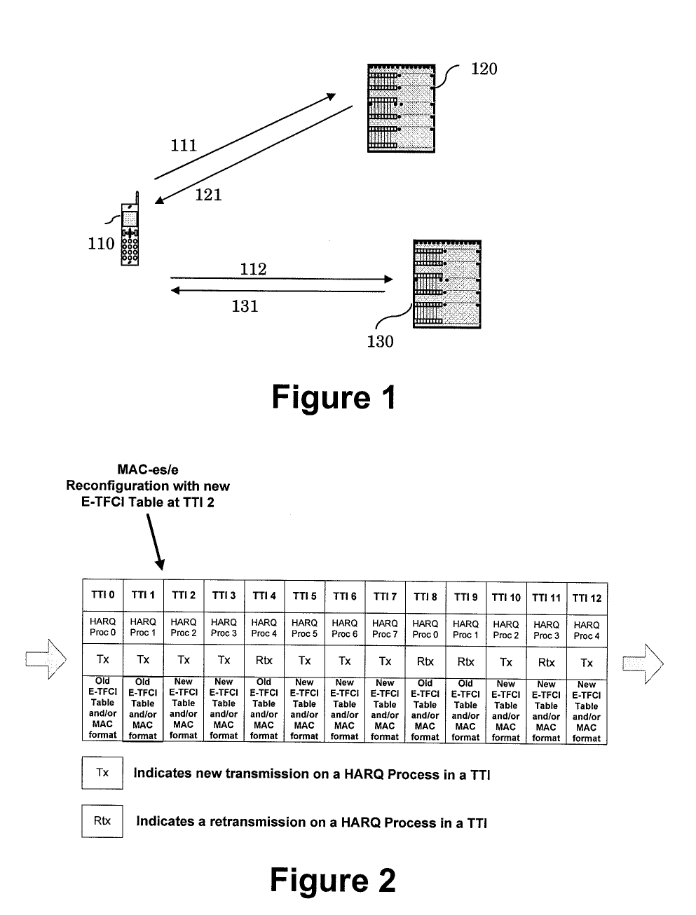

FIG. 1 illustrates signaling conducted during a soft handover of a WTRU 110 and from a base station 120 having uplink enhancements including, for example HOM support, (e-Node B) via uplink signaling 111 and downlink signaling 121 to a base station 130 that does not have such uplink enhancements (Node-B) via uplink signaling 112 and downlink signaling 131. Preferably, the enhanced WTRU and base stations are configured to operate in conformance with Third Generation Partnership Project (3GPP) standards so that the base stations are configured as Node Bs defined by 3GPP standards. For example, the WTRU 110 preferably includes a MAC component having selectively configurable subcomponents with HARQ buffers, such as MAC-es and MAC-e subcomponents or MAC-is and MACi subcomponents, configured to provide hybrid automatic repeat request (HARQ) functionality with enhanced dedicated transport channels (E-DCH).

In operation, various events will trigger a need to change the configuration of the MAC subcomponents and the specific setting that control how the subcomponents process communication data. Such reconfigurations are typically signaled through the communication of various MAC parameters as is well known in the art. In the case of a soft handover, the need to change MAC transmission parameters may occur so that the WTRU MAC component then reconfigures the subcomponents with the desired MAC transmission parameters.

Since the WTRU 110 is configured to use UL enhancements, it is able to send data to the e-Node-B 120, for example, using an enhanced dedicated channel (E-DCH) employing HOM based on an E-TFCI table that enables HOM via uplink signaling 111. However, no such UL E-DCH is available for the WTRU 110 to use to send data to the older version Node-B 130 via uplink signaling 112 and downlink signaling 131. Accordingly, the if the E-TFCI table being used to communicate with the e-Node-B 120 is not compatible with the Node-B joining the active set in a soft hand over situation, the WTRU must switch to an E-TFCI table compatible with both Node-Bs 120 and 130. This change of E-TFCI table is preferably indicated by an E-TFCI table index MAC parameter which is indicated to go into effect with respect to an activation time such as a specified TTI.

In one embodiment of the present invention, the WTRU MAC component is configured to reconfigure its subcomponents with a change in MAC transmission parameters, such as the E-TFCI table index for example, during a soft handover to utilize the new MAC transmission parameters starting at a specified TTI, except for completing HARQ processes on which a MAC PDU transmission was initiated before the but not completed by the specified TTI. Re-transmissions for such HARQ processes are performed using the previous MAC transmission parameters independent of the reconfiguration of the MAC transmission parameter, such as the E-TFCI table index, signaled by higher layers.

The MAC component preferably is configured to implement a procedure for reconfiguration of a MAC subcomponent, such as the MAC-es/e or MAC-is/i subcomponents, as follows:
a. Reconfiguration parameters for a MAC entity as determined by higher layers are received for implementation at a specified TTI;
b. Starting at the specified TTI parameter reconfigured values of the parameter are subsequently utilized with the following exception;
c. If selected parameters are reconfigured, such as the E-TFCI Table Index indicating a new E-TFCI table, the MAC entity generates re-transmission for any buffered, i.e. incomplete, HARQ processes as of the occurrence of the specified TTI using the previous MAC parameters, such as E-TFCI table for example. The new MAC parameters, such as the new E-TFCI table, are applied for new transmissions.
   Preferably, the parameters which are selected for triggering the excepted processing are parameters which would conventionally trigger the flushing of HARQ process buffers, so that completion of the HARQ processes already in progress is attempted.

In this manner, the receiving Node Bs uses the new MAC parameters, such as new E-TFCI table, for a given HARQ process once they receive a retransmission sequence number (RSN), i.e.; a retransmission sequence number, signaled over E-DPCCH, indicating a new transmission after the activation time. An example of the operation of this type of MAC reconfiguration is illustrated in FIG. 2 where the E-TFCI table index is changed.

With respect to the example of FIG. 2, the MAC component of a preferred WTRU receives reconfiguration parameters for its MAC sub-entities from higher layer signaling for implementation at TTI 2 that, in this example, include a changed E-TFCI Table Index parameter indicating a new E-TFCI table. Accordingly, prior to TTI 2, new transmissions Tx on a HARQ process were made using the prior or “old” E-TFCI Table as indicated for HARQ process 0 and HARQ process 1 in respective TTIs 0 and 1 as well as any other HARQ processes in prior TTIs. Starting with TTI 2, all new transmissions Txs on a HARQ processes are made using the new E-TFCI Table such as is indicated for TTIs 2, 3, 5, 6, 7, 10 and 12. However, any retransmission Rx on a HARQ process initiated by a new transmission Tx occurring before TTI 2 are made using the old E-TFCI Table. This is indicated for retransmission Rxs on HARQ processes 4, 0 and 1 with respect to TTIs 4, 8 and 9 respectively. Any retransmission Rx on a HARQ process initiated by a new transmission Tx occurring on or after TTI 2 are made using the new E-TFCI Table. This is indicated for retransmission Rx on HARQ process 3 with respect to TTI 11, since the new transmissions Tx on HARQ process 3 was made using the new E-TFCI Table in TTI 3.

In another embodiment where a WTRU is configured with the capability for UE enhancements, such as 16-QAM operation, i.e. UL HOM operation, or UL L2 Improvements, i.e. flexible size RLC PDUs and MAC segmentation, the WTRU's MAC component will be configured to implement reconfiguration of its HARQ process subcomponents for various modes such as a UL 16-QAM or UL L2 enhanced modes and other non-enhanced modes of operation. To do this, the WTRU's MAC component may be configured to utilize a new Information Element (IE) that indicates whether or not to flush its HARQ processes when reconfiguration parameters are received, after, for example, addition or deletion of a Node-b in a soft handover active set. Where an ACTIVE SET UPDATE message is used, such a new “flushing indicator” IE can be included within the message or within another IE already contained in the ACTIVE_SET_UPDATE message or within another IE contained in another message.

Where an ACTIVE SET UPDATE message or the like is received indicating reconfiguration parameters that may indicate that the WTRU is to operate in a UL 16-QAM mode or other enhanced mode, and a specific parameter or IE is not used to control whether or not HARQ processes are flushed, the WTRU is preferably configured to only flush HARQ processes when the reconfiguration parameters require the WTRU to change its mode, such as starting or stopping UL 16-QAM operation, i.e. UL HOM operation. Conventionally, an IE “UL 16QAM settings” may be included or omitted from a ACTIVE_SET_UPDATE message. Where flushing HARQ request processes are associated with the receipt of such ACTIVE_SET_UPDATE messages, the WTRU is preferably configured to flush HARQ request processes in connection with receipt of an ACTIVE_SET_UPDATE message including the IE “UL 16QAM settings” only if the WTRU is not currently operating in UL 16QAM mode and to flush HARQ request processes in connection with receipt of an ACTIVE_SET_UPDATE message omitting the IE “UL 16QAM settings” only if the WTRU is operating in UL 16QAM mode.

As an alternative to flushing, whether or not the above mentioned new “flushing indicator” IE is used, the WTRU can be configured to selectively start or continue operating in UL 16QAM mode or other enhanced mode after an activation time for a reconfiguration corresponding to the embodiment discussed with respect to FIG. 2. For example, where selective start or continued operation in UL 16QAM mode after an activation time is employed instead of flushing in connection with ACTIVE_SET_UPDATE messages, the WTRU is preferably configured to initiate new HARQ request processes after activation time using UL 16QAM mode in connection with receipt of an ACTIVE_SET_UPDATE message including the IE “UL 16QAM settings” and not initiate new HARQ request processes after activation time using UL 16QAM mode in connection with receipt of an ACTIVE_SET_UPDATE message omitting the IE “UL 16QAM settings.”

In another embodiment, the WTRU is preferably configured to perform MAC reconfiguration with “adapted” HARQ retransmissions. In such case, the WTRU attempts to complete all transmissions of HARQ processes on which a MAC PDU transmission was initiated before the activation time, but not completed at the activation time. The WTRU's MAC component is then preferably configured to complete previously initiated HARQ processes using a new set of MAC parameters, that may include a E-TFCI table index parameter, that is indicated by reconfiguration parameters received from higher layers. Where the E-TFCI table is changed in the new configuration, the WRTU is configured to select an E-TFC according to a smallest TB size that is capable of handling the original data. For example, a WTRU having a MAC component that includes MAC-d and MAC-e subcomponents is preferably configured to select an E-TFC according to a smallest TB size that is capable of handling the original data from MAC-d PDUs, i.e. MAC-d PDU data in MAC-e PDU prior to padding. Preferably, this is accomplished through use of a re-padding procedure that removes the MAC-d PDU padding added to create a MAC-e PDU that fit into a TB Size according to the original E-TFCI table and then to pad the MAC-d PDU to produce a MAC-e PDU that fits into a TB Size of the new E-TFCI table, which is preferably the smallest TB size larger or as large as the unpadded MAC-d PDU.

If the new E-TFCI table does not contain a TB Size large enough to contain the original data from the MAC-d PDU, then the WTRU can be configured to flush the associated HARQ processes. A further option to flushing HARQ processes with respect to such larger MAC-d PDU is set forth below with respect to another embodiment. Where the reconfiguration reduces the limits of the WTRU's TB sizes, preferably, the WTRU is configured to maintain its longer length service grant until completion of the HARQ processes initiated prior to the activation time, since the possibility exists that the above process would result TB sizes exceeding the reduced limits in a new service grant.

A WTRU having a MAC component configured to implement the above preferably is configured to operate as follows:
a. Reconfiguration parameters for MAC subcomponents as determined by higher layers are received for implementation at a specified TTI;
b. Starting at the specified TTI, reconfigured values of the parameters are subsequently utilized with the following exception;
c. If one or more selected parameters are reconfigured that indicate different TB sizes, such as the parameter E-TFCI Table Index is reconfigured indicating a new E-TFCI table, the respective MAC entity subcomponents apply the new parameters, such as a E-TFCI table, for all new transmissions and in the case of retransmissions, a PDU re-padding procedure is conducted to fit the data to be retransmitted into the smallest of the new TB sizes that is capable of handling the data, such as the closest E-TFCI in a new table that can contain the data.
d. If the re-padding procedure cannot be accomplished because the respective PDU is too large for the new TB sizes, such as the sizes indicated in a new E-TFCI table, the respective HARQ process is flushed.

In this manner, all Node Bs in an active set may use the new MAC parameters for decoding after the activation time without exception. However, the effectiveness of this embodiment is dependent on the redundancy procedures for HARQ processes used by the Node Bs. Where certain types of redundancy procedures are used by the Node B processing, the Node B may not be able use HARQ transmission that were transmitted prior to the activation time in order to decode the data after switching to the new configuration.

In a further embodiment, the WTRU is preferably configured to perform a MAC reconfiguration with a HARQ process reset that includes reprocessing of buffered data. In such a configuration, the WTRU's MAC component is preferably configured to reprocess data contained in the buffers of HARQ processes at the activation time for inclusion in new transmissions performed using the E-TFCI table and MAC protocol according to new reconfiguration implemented in connection with receiving reconfiguration parameters from higher layers. To achieve this, the WTRU's MAC component is preferably configured to extract the data from the HARQ process buffers for reprocessing in the reconfigured subcomponents. For example, the MAC component would extract MAC-d PDUs encapsulated in buffered MAC-e or MAC-i PDUs and the have the MAC-es/e or MAC-is/i entity subcomponents reprocess the MAC-d PDUs using the new set of MAC reconfiguration parameters. In such an example, the MAC-es/e or MAC-is/i subcomponent is preferably configured to then process the extracted MAC-d PDUs according to the E-TFC selection procedure based on any newly defined parameters resulting from the active set reconfiguration. In this embodiment, there exists the possibility that MAC-d PDUs that had initially been transmitted together in the same MAC-e or MAC-i PDU using the original E-TFCI table are re-transmitted in different MAC-e or MAC-i PDUs under the newly defined E-TFCI table index.

For a WTRU configured to operate using Improved L2, the example reprocessing is provided below for two different scenarios. In such cases, the WTRU's MAC component is preferably configured with MACes/e subcomponents for processing in at least one non-improved L2 mode and also MAC/is/i subcomponents for processing in at least one improved L2 mode.

When a reconfiguration from a non-improved L2 protocol, i.e. Release 7 and earlier, to a Improved L2 protocol, i.e. Release 8 and beyond, the WTRU's MAC component is preferably configured to extract dedicated MAC (MAC-d/c) PDUs from MAC-e PDUs in the buffers of the HARQ processes and create MAC-i PDUs using the new Improved L2 protocol header format. This procedure is easily implemented due to the fact that the new improved L2 protocol can support MAC-d/c PDUs of different sizes. Preferably, the CURRENT_TSN number used in the MAC-es format is not reset and the transmission of the new MAC-i PDUs is performed. Alternatively, the CURRENT_TSN may be reset to an initial value, typically 0.

When a reconfiguration from an Improved Layer 2 protocol to a non-Improved layer 2 protocol occurs, implementation is more difficult, due to the fact that the non-improved layer 2 MAC protocol does not support transmission of flexible MAC-d/c PDUs. In one preferred implementation of this embodiment, MAC-d/c PDUs are extracted from buffers of the HARQ processes and the MAC component is configured to attempt to create MAC-e/es PDUs. If any segments are present in the MAC-is/i entity, the MAC is preferably configured to also attempt to retransmit the segments together with the extracted MAC-is/i PDUs. Preferably padding of the extracted MAC-d/c PDUs is employed such that a size that matches one of the configured set of Data Description Indicator (DDI) sizes is created. The DDI is the MAC-e header field used to identify the logical channel, MAC-d flow and the size of the MAC-d PDUs concatenated into a MAC-es PDU. The padded MAC-dl/c PDUs are then used to create MAC-es PDUs. If multiple MAC-d/c PDUs from the same logical channel are present, the size of all MAC-d/c PDUs that will be included in the MAC-e/es have to be the same size. The WTRU MAC component is preferably configured to provide a different amount of padding bits for each MAC-d/c PDU, accordingly as needed. If the MAC-d/c PDU is larger than the selected TB size, the WTRU is preferably configured to discard the PDU, but can be configured to wait for the next TTI to attempt transmission. The receiving Node B in then preferably configured to appropriately remove the padding bits.

Alternatively, the WTRU's MAC component can be configured to flush all the MAC-i PDUs in the HARQ process and discard all remaining segments in the MAC-is/i entity.

As a further alternative, the WTRU's MAC component can be configured to flush the MAC-i or MAC-e PDUs in HARQ processes, but attempt to transmit segments remaining in the buffer, if any segments are stored. The remaining segments are preferably transmitted using the reconfigured MAC protocol. To ensure the correct transmission of the segment, the WTRU MAC component is preferably configured to add padding bits to make the segment match one of the configured Data Description Indicator (DDI) sizes. Optionally, the segment may be retransmitted if the previous segments of the same PDU have been successfully transmitted. Otherwise, if one of the IARQ processes contains the previous segment, the WTRU MAC component is preferably configured to either discard any remaining segments, or extract only remaining segments in the HARQ buffer, optionally to recombine them with the stored segments and attempt to transmit it.

In another embodiment, a WTRU is preferably configured to implement MAC-es/e or MAC-is/i reconfiguration with MAC-es/e or MAC-is/i resets which flush all HARQ processes. To alleviate latency impact brought about by the flushing of the HARQ processes, the WTRU is preferably configured to utilize a set of one or more primitives between the MAC component and the RLC component, allowing the MAC-es/e or MAC-is/i to notify the RLC. Optionally this may include a primitive involving the MAC-d layer subcomponent indicating that RLC PDUs associated with flushed HARQ processes have failed by, for example, identifying RCL PDUs encapsulated in PDUs stored in the HARQ buffer at the activation time of a reconfiguration. This allows the RLC layer to re-send the RLC PDUs to the MAC without having to wait for a negative acknowledgment from its peer RLC entity. This procedure reduces the latency induced by MAC-es/e or MAC-is/I reconfiguration under operation in RLC acknowledged mode.

The WTRU MAC component is preferably configured to implement MAC-es/e or MAC-is/i procedures for this embodiment as follows:
When request to reset the MAC-es/e or MAC-is/i entity is received from higher layers specifying an activation time, at the activation time the MAC component proceeds to:
   flush all HARQ processes;
   reinitialize MAC-es or MAC-is headers, for example by setting CURRENT_TSN to 0 for all the logical channels mapped to E-DCH;
   apply new E-DCH configuration parameters, e.g. new E-TFCI table index, for subsequent transmissions, if included in the request from higher layers; and
   send an indication to higher layers of the failure to successfully transmit the data that had been in the HARQ process buffers, preferably indicating the specific segmented RLC Suds forming the RLC PDUs for the MAC-e PDUs through the use of the added primitives.

Optionally, the WTRU MAC component can be configured to trigger the transmission of a new Scheduling Information IE for cases where, for example, a HARQ process with a MAC-e PDU containing a triggered Scheduling Information has been flushed.

Although the features and elements of the present invention are described in the preferred embodiments in particular combinations, each feature or element can be used alone without the other features and elements of the preferred embodiments or in various combinations with or without other features and elements of the present invention. The methods or flow charts provided in the present invention may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (WTRU), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A wireless transmit receive unit (WTRU) comprising:
a configurable medium access control (MAC) component having a subcomponent configured to provide hybrid automatic repeat request (HARQ) functionality with enhanced dedicated transport channels (E-DCH); and
the MAC component configured to implement a reconfiguration of the MAC subcomponent at an activation time from a first configuration to a second configuration based upon receipt of reconfiguration parameters such that the second configuration is used by the MAC subcomponent subsequent to the activation time, except for incomplete HARQ processes existing at the activation time, and at least a portion of the first configuration is used by the MAC subcomponent for completion of incomplete HARQ processes existing at the activation time.

2. The WTRU of claim 1 wherein the MAC subcomponent is configured to implement MAC-e and MAC-es protocol sub-layer functionality for the WTRU.

3. The WTRU of claim 1 wherein the MAC subcomponent is configured to implement MAC-i and MAC-is protocol sub-layer functionality for the WTRU.

4. The WTRU of claim 1 wherein:
the MAC component is configured to implement reconfiguration of the MAC subcomponent for a plurality of operational modes including enhanced modes of operation and non-enhanced modes of operation;
the MAC component is configured to utilize an enhanced mode of operation for HARQ processes initiated after the activation time in implementing a reconfiguration of the MAC subcomponent where the first configuration uses a non-enhanced mode of operation and the second configuration uses the enhanced mode of operation; and
the MAC component is configured to not to utilize an enhanced mode of operation for HARQ processes initiated after the activation time in implementing a reconfiguration of the MAC subcomponent where the first configuration uses the enhanced mode of operation and the second configuration uses a non-enhanced mode of operation.

5. The WTRU according to claim 4 wherein the MAC subcomponent has an uplink 16 QAM mode of operation and the MAC component is configured to receive an ACTIVE SET UPDATE message to trigger a reconfiguration of the MAC subcomponent to a different mode of operation wherein:
the MAC component is configured to utilize the uplink 16 QAM mode of operation for HARQ processes initiated after the activation time in implementing a reconfiguration of the MAC subcomponent where the first configuration uses a non-enhanced mode of operation and the second configuration uses the uplink 16 QAM mode of operation; and
the MAC component is configured to not to utilize the uplink 16 QAM mode of operation for HARQ processes initiated after the activation time in implementing a reconfiguration of the MAC subcomponent where the first configuration uses the uplink 16 QAM mode of operation and the second configuration uses a non-enhanced mode of operation.

6. The WTRU of claim 5 wherein the MAC subcomponent is configured to implement MAC-e and MAC-es protocol sub-layer functionality for the WTRU.

7. A method for facilitating wireless communications comprising:
providing a configurable medium access control (MAC) component having a subcomponent configured to provide hybrid automatic repeat request (HARQ) functionality with enhanced dedicated transport channels (E-DCH); and
implementing a reconfiguration of the MAC subcomponent from a first configuration to a second configuration at an activation time based upon receipt of reconfiguration parameters such that the second configuration is used by the MAC subcomponent subsequent to the activation time, except for incomplete HARQ processes existing at the activation time, and at least a portion of the first configuration is used by the MAC subcomponent for completion of incomplete HARQ processes existing at the activation time.

8. The method of claim 7 where the MAC subcomponent is configurable into a plurality of operational modes including enhanced modes of operation and non-enhanced modes of operation wherein:
an enhanced mode of operation is used for HARQ processes initiated after the activation time in connection with implementing a reconfiguration of the MAC subcomponent where the first configuration uses a non-enhanced mode of operation and the second configuration uses the enhanced mode of operation; and
an enhanced mode of operation is not used for HARQ processes initiated after the activation time in connection with implementing a reconfiguration of the MAC subcomponent where the first configuration uses the enhanced mode of operation and the second configuration uses a non-enhanced mode of operation.

9. The method of claim 8 wherein the MAC subcomponent has an uplink 16 QAM mode of operation and further comprising receiving an ACTIVE SET UPDATE message to trigger a reconfiguration of the MAC subcomponent to a different mode of operation such that:
the uplink 16 QAM mode of operation is used for HARQ processes initiated after the activation time in connection with implementing a reconfiguration of the MAC subcomponent where the first configuration uses a non-enhanced mode of operation and the second configuration uses the uplink 16 QAM mode of operation; and
the uplink 16 QAM mode of operation is not used for HARQ processes initiated after the activation time in connection with implementing a reconfiguration of the MAC subcomponent where the first configuration uses the uplink 16 QAM mode of operation and the second configuration uses a non-enhanced mode of operation.

10. A wireless transmit receive unit (WTRU) comprising:
a configurable medium access control (MAC) component having a subcomponent configured to provide hybrid automatic repeat request (HARQ) functionality;
the MAC component configured to implement reconfiguration of the MAC subcomponent for a plurality of operational modes including an enhanced mode and a non-enhanced mode; and
the MAC component configured to utilize an Information Element (IE) that specifically indicates whether or not to flush HARQ processes in connection with implementing a reconfiguration of the MAC subcomponent from one operational mode to another.

11. The WTRU according to claim 10 wherein the MAC subcomponent has an uplink 16 QAM mode of operation as an enhanced mode of operation and the MAC component is configured to receive an ACTIVE SET UPDATE message to trigger a reconfiguration of the MAC subcomponent to a different mode of operation wherein the IE is included within the ACTIVE SET UPDATE message, within another IE contained in the ACTIVE_SET_UPDATE message or within another IE contained in another message.

12. The WTRU of claim 10 wherein the MAC subcomponent is configured to implement MAC-e and MAC-es protocol sub-layer functionality for the WTRU and includes a buffer for temporarily storing retransmission data associated with initiated HARQ processes that is cleared when HARQ processes are flushed.

13. The WTRU of claim 10 wherein the MAC subcomponent is configured to implement MAC-i and MAC-is protocol sub-layer functionality for the WTRU and includes a buffer for temporarily storing retransmission data associated with initiated HARQ processes that is cleared when HARQ processes are flushed.

14. The WTRU according to claim 13 wherein the MAC subcomponent has an uplink L2 mode of operation as an enhanced mode of operation and the MAC component is configured to receive an ACTIVE SET UPDATE message to trigger a reconfiguration of the MAC subcomponent to a different mode of operation wherein the IE is included within the ACTIVE SET UPDATE message, within another IE contained in the ACTIVE_SET_UPDATE message or within another IE contained in another message.

15. A method for facilitating wireless communication comprising:
providing a wireless transmit receive unit (WTRU) having a configurable medium access control (MAC) component that has a subcomponent configured to provide hybrid automatic repeat request (HARQ) functionality wherein the MAC subcomponent for a plurality of operational modes including an enhanced mode and a non-enhanced mode; and
utilizing an Information Element (IE) that specifically indicates whether or not to flush HARQ processes in connection with implementing a reconfiguration of the MAC subcomponent from one operational mode to another.

16. The method according to claim 15 wherein the MAC subcomponent has an uplink 16 QAM mode of operation and further comprising receiving an ACTIVE SET UPDATE message to trigger a reconfiguration of the MAC subcomponent to a different mode of operation wherein the IE is included within the ACTIVE SET UPDATE message, within another IE contained in the ACTIVE_SET_UPDATE message or within another IE contained in another message.

17. A wireless transmit receive unit (WTRU) comprising:
a configurable medium access control (MAC) component having a subcomponent configured to provide hybrid automatic repeat request (HARQ) functionality;
the MAC component configured to implement reconfiguration of the MAC subcomponent for a plurality of operational modes including enhanced modes of operation and non-enhanced modes of operation;
the MAC component configured to flush HARQ processes in implementing a reconfiguration of the MAC subcomponent which changes the mode of operation from an enhanced mode of operation to a non-enhanced mode of operation or from a non-enhanced mode of operation to an enhanced mode of operation; and
the MAC component configured not to flush HARQ processes in implementing a reconfiguration of the MAC subcomponent which does not change the mode of operation from an enhanced mode of operation to a non-enhanced mode of operation or from a non-enhanced mode of operation to an enhanced mode of operation.

18. The WTRU according to claim 17 wherein the MAC subcomponent has an uplink 16 QAM mode of operation and the MAC component is configured to receive an ACTIVE SET UPDATE message to trigger a reconfiguration of the MAC subcomponent to a different mode of operation wherein:
the MAC component is configured to flush HARQ processes in implementing a reconfiguration of the MAC subcomponent which changes the mode of operation from the an uplink 16 QAM enhanced mode of operation to a non-enhanced mode of operation in response to the inclusion of an UL 16QAM settings Information Element in a triggering ACTIVE SET UPDATE message or from a non-enhanced mode of operation to an enhanced mode of operation in response to the omission of an UL 16QAM settings Information Element in a triggering ACTIVE SET UPDATE message; and
the MAC component configured not to flush HARQ processes in implementing a reconfiguration of the MAC subcomponent which does not change the mode of operation from an enhanced mode of operation to a non-enhanced mode of operation or from a non-enhanced mode of operation to an enhanced mode of operation irrespective of whether an UL 16QAM settings Information Element in a triggering ACTIVE SET UPDATE message is included or omitted.

19. The WTRU of claim 18 wherein the MAC subcomponent is configured to implement MAC-e and MAC-es protocol sub-layer functionality for the WTRU and includes a buffer for temporarily storing retransmission data associated with initiated HARQ processes that is cleared when HARQ processes are flushed.

20. The WTRU of claim 17 wherein the MAC subcomponent is configured to implement MAC-i and MAC-is protocol sub-layer functionality for the WTRU and includes a buffer for temporarily storing retransmission data associated with initiated HARQ processes that is cleared when HARQ processes are flushed.

21. A method for facilitating wireless communication comprising:
providing a wireless transmit receive unit (WTRU) having a configurable medium access control (MAC) component that has a subcomponent configured to provide hybrid automatic repeat request (HARQ) functionality and a plurality of operational modes including enhanced modes of operation and non-enhanced modes of operation;
flushing HARQ processes in implementing a reconfiguration of the MAC subcomponent which changes the mode of operation from an enhanced mode of operation to a non-enhanced mode of operation or from a non-enhanced mode of operation to an enhanced mode of operation; and
not flushing HARQ processes in implementing a reconfiguration of the MAC subcomponent which does not change the mode of operation from an enhanced mode of operation to a non-enhanced mode of operation or from a non-enhanced mode of operation to an enhanced mode of operation.

22. The method according to claim 21 where the MAC subcomponent has an uplink 16 QAM mode of operation and further comprising receiving an ACTIVE SET UPDATE message to trigger a reconfiguration of the MAC subcomponent to a different mode of operation such that:
HARQ processes are flushed in implementing a reconfiguration of the MAC subcomponent which changes the mode of operation from the an uplink 16 QAM enhanced mode of operation to a non-enhanced mode of operation in response to the inclusion of an UL 16QAM settings Information Element in a triggering ACTIVE SET UPDATE message or from a non-enhanced mode of operation to an enhanced mode of operation in response to the omission of an UL 16QAM settings Information Element in a triggering ACTIVE SET UPDATE message; and
HARQ processes are not flushed in implementing a reconfiguration of the MAC subcomponent which does not change the mode of operation from an enhanced mode of operation to a non-enhanced mode of operation or from a non-enhanced mode of operation to an enhanced mode of operation irrespective of whether an UL 16QAM settings Information Element in a triggering ACTIVE SET UPDATE message is included or omitted.

23. A wireless transmit receive unit (WTRU) comprising:
a configurable medium access control (MAC) component having a subcomponent configured to provide hybrid automatic repeat request (HARQ) functionality with enhanced dedicated transport channels (E-DCH);
the MAC component configured to implement a reconfiguration of the MAC subcomponent at an activation time from a first configuration to a second configuration based upon receipt of reconfiguration parameters;
the MAC subcomponent having a plurality of operational modes including enhanced modes of operation and non-enhanced modes of operation;
the MAC component configured to utilize an enhanced mode of operation for HARQ processes initiated after the activation time in implementing a reconfiguration of the MAC subcomponent where the first configuration uses a non-enhanced mode of operation and the second configuration uses the enhanced mode of operation; and
the MAC component configured to not to utilize an enhanced mode of operation for HARQ processes initiated after the activation time in implementing a reconfiguration of the MAC subcomponent where the first configuration uses the enhanced mode of operation and the second configuration uses a non-enhanced mode of operation.

24. The WTRU according to claim 23 wherein the MAC subcomponent has an uplink 16 QAM mode of operation and the MAC component is configured to receive an ACTIVE SET UPDATE message to trigger a reconfiguration of the MAC subcomponent to a different mode of operation wherein:
the MAC component is configured to utilize the uplink 16 QAM mode of operation for HARQ processes initiated after the activation time in implementing a reconfiguration of the MAC subcomponent where the first configuration uses a non-enhanced mode of operation and the second configuration uses the uplink 16 QAM mode of operation; and
the MAC component is configured to not to utilize the uplink 16 QAM mode of operation for HARQ processes initiated after the activation time in implementing a reconfiguration of the MAC subcomponent where the first configuration uses the uplink 16 QAM mode of operation and the second configuration uses a non-enhanced mode of operation.

25. The WTRU of claim 24 wherein the MAC subcomponent is configured to implement MAC-e and MAC-es protocol sub-layer functionality for the WTRU.

26. The WTRU of claim 23 wherein the MAC subcomponent is configured to implement MAC-i and MAC-is protocol sub-layer functionality for the WTRU.

27. A method for facilitating wireless communications comprising:
providing a configurable medium access control (MAC) component having a subcomponent configured to provide hybrid automatic repeat request (HARQ) functionality with enhanced dedicated transport channels (E-DCH) where the MAC subcomponent has a plurality of operational modes including enhanced modes of operation and non-enhanced modes of operation;
implementing a reconfiguration of the MAC subcomponent from a first configuration to a second configuration at an activation time based upon receipt of reconfiguration parameters;
using an enhanced mode of operation for HARQ processes initiated after the activation time in connection with implementing a reconfiguration of the MAC subcomponent where the first configuration uses a non-enhanced mode of operation and the second configuration uses the enhanced mode of operation; and
not using an enhanced mode of operation for HARQ processes initiated after the activation time in connection with implementing a reconfiguration of the MAC subcomponent where the first configuration uses the enhanced mode of operation and the second configuration uses a non-enhanced mode of operation.

28. The method of claim 27 wherein the MAC subcomponent has an uplink 16 QAM mode of operation and further comprising receiving an ACTIVE SET UPDATE message to trigger a reconfiguration of the MAC subcomponent to a different mode of operation such that:
the uplink 16 QAM mode of operation is used for HARQ processes initiated after the activation time in connection with implementing a reconfiguration of the MAC subcomponent where the first configuration uses a non-enhanced mode of operation and the second configuration uses the uplink 16 QAM mode of operation; and
the uplink 16 QAM mode of operation is not used for HARQ processes initiated after the activation time in connection with implementing a reconfiguration of the MAC subcomponent where the first configuration uses the uplink 16 QAM mode of operation and the second configuration uses a non-enhanced mode of operation.

29. A wireless transmit receive unit (WTRU) comprising:
a configurable medium access control (MAC) component having a subcomponent configured to provide hybrid automatic repeat request (HARQ) functionality with enhanced dedicated transport channels (E-DCH);
the MAC subcomponent including a buffer for temporarily storing retransmission data associated with initiated HARQ processes; and
the MAC component configured to implement a reconfiguration of the MAC subcomponent at an activation time from a first configuration to a second configuration based upon receipt of reconfiguration parameters such that the second configuration is used by the MAC subcomponent subsequent to the activation time, and data stored in the buffer with respect to incomplete HARQ processes existing at the activation time is reprocessed for possible transmission using the second configuration.

30. The WTRU of claim 29 wherein the MAC subcomponent is configured to implement MAC-e and MAC-es protocol sub-layer functionality for the WTRU.

31. The WTRU of claim 29 wherein the MAC subcomponent is configured to implement MAC-i and MAC-is protocol sub-layer functionality for the WTRU.

32. The WTRU of claim 29 wherein:
the MAC subcomponent has a plurality of configurations which operate to encapsulate data into transport blocks (TB) having selected sizes where there are at least two different configurations that use different sets of TB sizes;
the MAC subcomponent when operating in a selected configuration is configured to use the buffer to temporarily store data that has been encapsulated and padded into TBs that are sized in accordance with the set of TB sizes used by the selected configuration; and
the MAC component is configured to implement a reconfiguration of the MAC subcomponent at an activation time from a first configuration to a second configuration based upon receipt of reconfiguration parameters such that data stored in the buffer with respect to incomplete HARQ processes existing at the activation time is reprocessed by extracting the encapsulated data stored in the buffer and performing a re-padding procedure to fit the extracted data into TBs of a size used by the second configuration unless the extracted data is too large for any of the TBs used by the second configuration.

33. The WTRU of claim 29 wherein:
the MAC subcomponent has a plurality of configurations which operate to encapsulate data into transport blocks (TB) having selected sizes such that the configurations include:
a MAC-es/e configuration wherein the MAC subcomponent is configured to implement MAC-e and MAC-es protocol sub-layer functionality for the WTRU in which data associated with HARQ processes is stored in the buffer in the form MAC-e protocol data units; and
a MAC-is/i configuration wherein the MAC subcomponent is configured to implement MAC-i and MAC-is protocol sub-layer functionality for the WTRU in which data associated with HARQ processes is stored in the buffer in the form MAC-i protocol data units; and
the MAC component is configured to implement a reconfiguration of the MAC subcomponent at an activation time from the MAC-es/e configuration to the MAC-is/i configuration based upon receipt of reconfiguration parameters such that the MAC-is/i configuration is used by the MAC subcomponent subsequent to the activation time, and data stored in the buffer as MAC-e protocol data units with respect to incomplete HARQ processes existing at the activation time is reprocessed into MAC-i protocol data units for transmission using the MAC-is/i configuration.

34. A method for facilitating wireless communications comprising:
providing a configurable medium access control (MAC) component having a subcomponent configured to provide hybrid automatic repeat request (HARQ) functionality with enhanced dedicated transport channels (E-DCH) where the MAC subcomponent has a buffer for temporarily storing retransmission data associated with initiated HARQ processes; and
implementing a reconfiguration of the MAC subcomponent at an activation time from a first configuration to a second configuration based upon receipt of reconfiguration parameters such that the second configuration is used by the MAC subcomponent subsequent to the activation time, and data stored in the buffer with respect to incomplete HARQ processes existing at the activation time is reprocessed for possible transmission using the second configuration.

35. The method of claim 34 where the MAC subcomponent has a plurality of configurations which operate to encapsulate data into transport blocks (TB) having selected sizes where there are at least two different configurations the use different sets of TB sizes and the MAC subcomponent when operating in a selected configuration is configured to use the buffer to temporarily store data that has been encapsulated and padded into TBs that are sized in accordance with the set of TB sizes used by the selected configuration, the method wherein the implementing of a reconfiguration of the MAC subcomponent at an activation time from a first configuration to a second configuration based upon receipt of reconfiguration parameters is performed such that data stored in the buffer with respect to incomplete HARQ processes existing at the activation time is reprocessed by extracting the encapsulated data stored in the buffer and performing a re-padding procedure to fit the extracted data into TBs of a size used by the second configuration unless the extracted data is too large for any of the TBs used by the second configuration.

36. The method of claim 34 where the MAC subcomponent has a plurality of configurations which operate to encapsulate data into transport blocks (TB) having selected sizes such that the configurations include a MAC-es/e configuration wherein the MAC subcomponent is configured to implement MAC-e and MAC-es protocol sub-layer functionality for the WTRU in which data associated with HARQ processes is stored in the buffer in the form MAC-e protocol data units and a MAC-is/i configuration wherein the MAC subcomponent is configured to implement MAC-i and MAC-is protocol sub-layer functionality for the WTRU in which data associated with HARQ processes is stored in the buffer in the form MAC-i protocol data units, the method wherein:
a reconfiguration of the MAC subcomponent is implemented at the activation time from the MAC-es/e configuration to the MAC-is/i configuration based upon receipt of reconfiguration parameters such that the MAC-is/i configuration is used by the MAC subcomponent subsequent to the activation time, and data stored in the buffer as MAC-e protocol data units with respect to incomplete HARQ processes existing at the activation time is reprocessed into MAC-i protocol data units for transmission using the MAC-is/i configuration.

37. A wireless transmit receive unit (WTRU) comprising:
a configurable medium access control (MAC) component having a subcomponent configured to provide hybrid automatic repeat request (HARQ) functionality;
the MAC subcomponent including a buffer for temporarily storing retransmission data associated with initiated HARQ processes;
the MAC component configured to implement a reconfiguration of the MAC subcomponent at an activation time from a first configuration to a second configuration based upon receipt of reconfiguration parameters such that the second configuration is used by the MAC subcomponent subsequent to the activation time and incomplete HARQ processes existing at the activation time are flushed;
a radio link control (RLC) component configured to implement RLC sub-layer functionality for the WTRU including the communication of data with the MAC component in RLC packet data units (PDUs); and
the MAC component and the RLC component configured to utilize a set of primitives to identify incomplete HARQ processes existing at the activation time.

38. The WTRU of claim 37 wherein:
the MAC component is configured to encapsulate RLC PDUs in MAC subcomponent PDUs for transmission and to temporarily store MAC subcomponent PDUs associated with initiated HARQ processes in the buffer; and
the MAC component and the RLC component are configured to utilize the set of primitives to identify encapsulated RLC PDUs in MAC subcomponent PDUs stored in the buffer for incomplete HARQ processes existing at the activation time.

39. The WTRU of claim 37 wherein the MAC subcomponent is configured to implement MAC-e and MAC-es protocol sub-layer functionality for the WTRU.

40. The WTRU of claim 37 wherein the MAC subcomponent is configured to implement MAC-i and MAC-is protocol sub-layer functionality for the WTRU.

41. A method for facilitating wireless communications comprising:
providing a configurable medium access control (MAC) component having a subcomponent configured to provide hybrid automatic repeat request (HARQ) functionality where the MAC subcomponent including a buffer for temporarily storing retransmission data associated with initiated HARQ processes;
implementing a reconfiguration of the MAC subcomponent at an activation time from a first configuration to a second configuration based upon receipt of reconfiguration parameters such that the second configuration is used by the MAC subcomponent subsequent to the activation time and incomplete HARQ processes existing at the activation time are flushed;
providing a radio link control (RLC) component configured to implement RLC sub-layer functionality for the WTRU including the communication of data with the MAC component in RLC packet data units (PDUs); and
utilizing a set of primitives to identify incomplete HARQ processes existing at the activation time.

42. The method of claim 41 further comprising:
encapsulating RLC PDUs in MAC subcomponent PDUs for transmission;
temporarily storing MAC subcomponent PDUs associated with initiated HARQ processes in the buffer; and
utilizing the set of primitives to identify encapsulated RLC PDUs in MAC subcomponent PDUs stored in the buffer for incomplete HARQ processes existing at the activation time.
